(19) United States
(12) Patent Application Publication
(10) Pub. No.: US 2012/0292467 A1
(43) Pub. Date: Nov. 22, 2012

(54) BRACKET FOR HOLDING HOUSEHOLDS

(75) Inventor: YUN-LUNG CHEN, Tu-Cheng (TW)

(73) Assignee: HON HAI PRECISION INDUSTRY CO., LTD., Tu-Cheng (TW)

(21) Appl. No.: 13/366,295

(22) Filed: Feb. 4, 2012

(30) Foreign Application Priority Data
May 20, 2011 (CN) 201110131655.9

(51) Int. Cl. F16B 47/00

(52) U.S. Cl. 248/206.2

(57) ABSTRACT

A bracket for holding a household is disclosed. The bracket include an installation member, the installation member including an installation body, a receiving portion and a limiting portion located on the installation body, and a latching opening defined in the receiving portion; an attachment dish, the attachment dish including a suction cup for sucking on a plane, a connecting portion extending from the suction cup, and a latching portion extending from the connecting portion; the latching portion elastically engaged between the receiving portion and the limiting portion; and the connecting portion engaged in the latching opening; and a placing member rotatably secured to the installation member for supporting the household item.

### BACKGROUND

1. Technical Field

The present disclosure relates to brackets, and more particularly to a bracket for holding a commodity.

2. Description of Related Art

A user uses many households, such as pens, toothbrushes, razors or soap, on a daily basis. The households may be placed disorderly everywhere, which may be time-consuming when the user tries to find a particular household item as needed.

Therefore, there is room for improvement in the art.

### BRIEF DESCRIPTION OF THE DRAWINGS

Many aspects of the embodiments can be better understood with references to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is an exploded, isometric view of an embodiment of a bracket.

FIG. 2 is similar to FIG. 1, but viewed in a different aspect.

FIG. 3 is an isometric view of the installation member of FIG. 1.

FIG. 4 is an assembled view of the bracket of FIG. 1.

FIG. 5 is a cross-sectional view of the bracket view of FIG. 4, taken along the line V-V.

FIG. 6 is an assembled view of the bracket of FIG. 1 and a razor.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

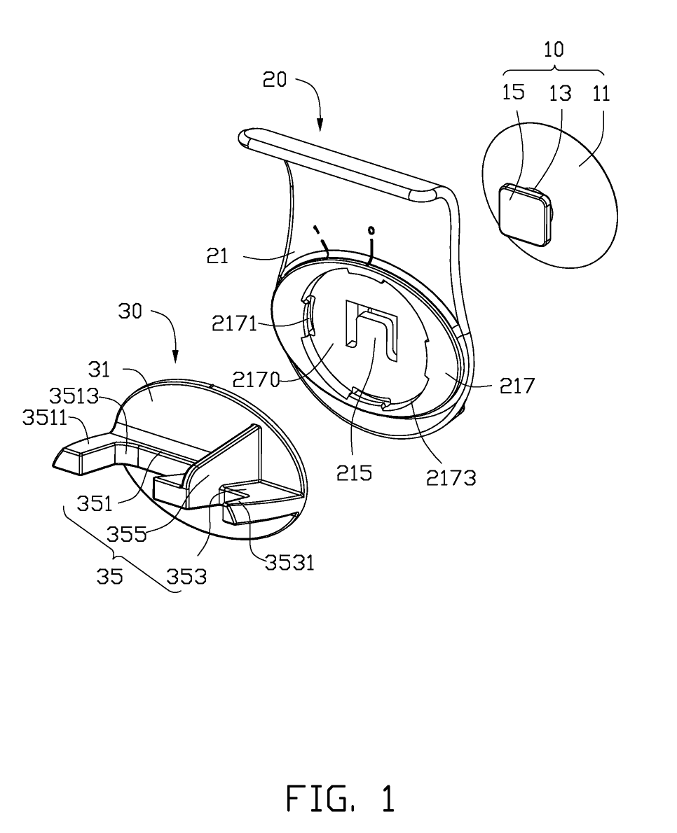

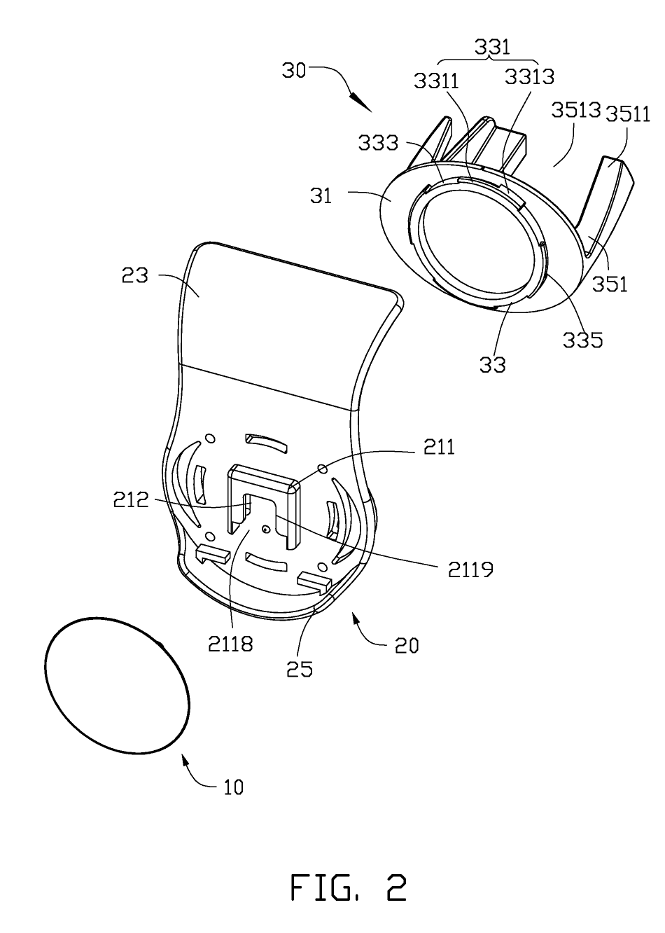

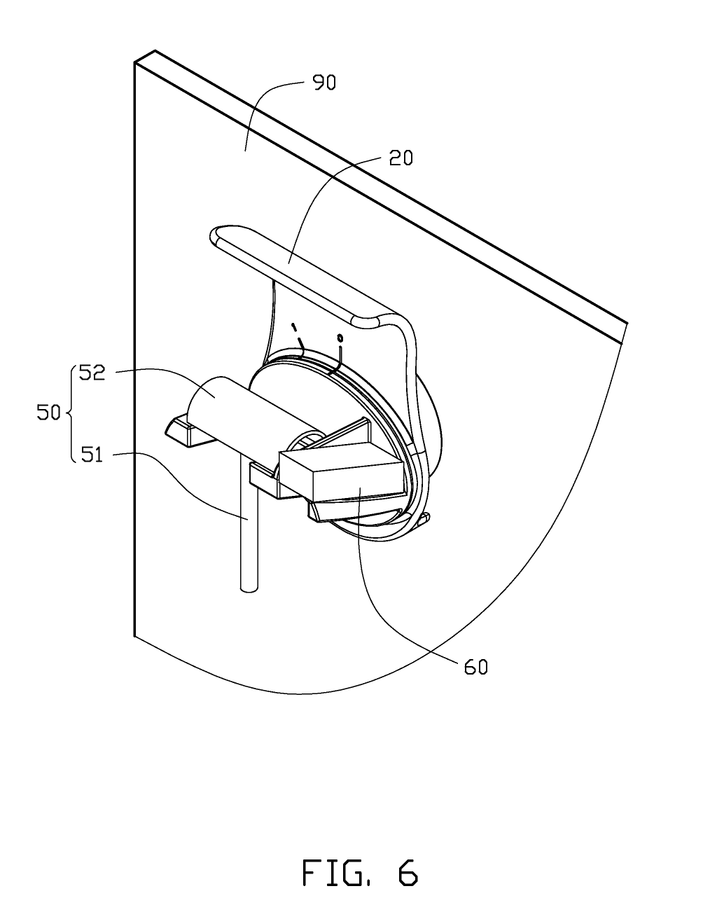

Referring to FIGS. 1 and 2, a bracket in accordance with an embodiment comprises an attachment dish 10, an installation member 20 and a placing member 30. In one embodiment, the bracket is used for placing a commodity, such as a razor 50 (shown in FIG. 6).

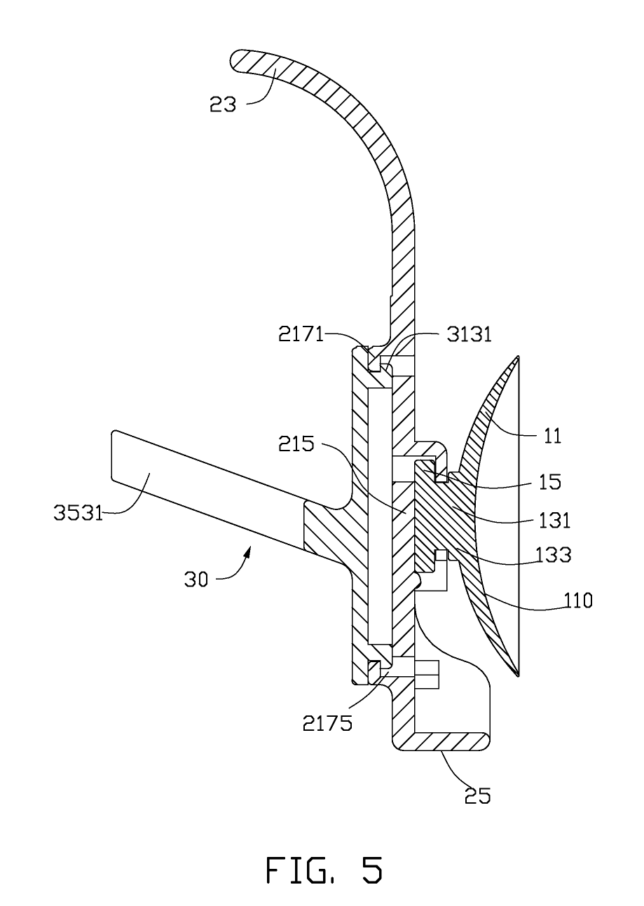

The attachment dish 10 comprises a suction cup 11, a connecting portion 13 extending from the suction cup 11, and a latching portion 15 extending from the connecting portion 13. In one embodiment, the attachment dish 10 can be attached to a plane 90. The suction cup 11 defines an arc surface 110 (shown in the FIG. 5) opposite to the connecting portion 13. The connecting portion 13 comprises a pressing portion 131 extending from the suction cup 11, and a neck portion 133 extending from the pressing portion 131. In one embodiment, the cross-sectional size of the neck portion 133 is less than the cross-sectional size of the latching portion 15 and the cross sectional size of the pressing portion 131.

The installation member 20 comprises an installation body 21, a covering portion 23 extending from one end of the installation body 21, and an abutting portion 25 extending from another end of the installation body 21.

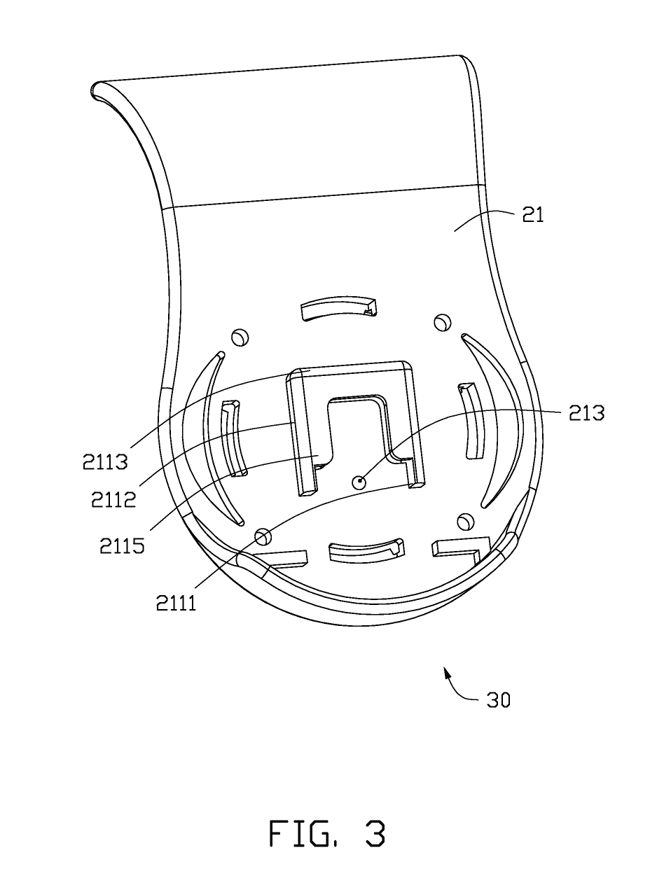

A receiving portion 211 is convexly located on one side of the installation body 21. In one embodiment, the shape of the receiving portion 211 is substantially rectangular. Referring to FIG. 3, the receiving portion 211 comprises a first sidewall 2111, a second sidewall 2112, a top wall 2113 connected to the first sidewall 2111 and the second sidewall 2112, and a side board 2115. The first sidewall 2111, the second sidewall 2112, the top wall 2113, the side board 2115 and the installation body 21 together define a receiving space 212. The first sidewall 2111, the second sidewall 2112 and the top wall 2113 separately extend from the installation body 21. In one embodiment, the first sidewall 2111 is substantially parallel to the second sidewall 2112; the first sidewall 2111, the second sidewall 2112 and the top wall 2113 are substantially perpendicular with the installation body 21. The side board 2115 is connected to the first sidewall 2111, the second sidewall 2112 and the top wall 2113. In one embodiment, the side board 2115 is substantially parallel to the installation body 21. The receiving portion 211 defines an entrance 2118 between the first sidewall 2111 and the second sidewall 2112. The side board 2115 defines a latching opening 2119 communicating with the entrance 2118. A protrusion 213 is located on the installation body 21 in the entrance 2118. A limiting portion 215 is disposed in the installation body 21 in back of the side board 2115.

An installation portion 217 is convexly located on another side of the installation body 21. In one embodiment, the outer edge shape of the installation portion 217 is substantially oval-shaped. An installation slot 2170 is defined in the installation portion 217. The inside wall edge of the installation slot 2170 is provided with a plurality of blocking lumps 2171. Adjacent two of the plurality of blocking lumps 2171 defines an installation groove 2173. A blocking slot 2175 is defined in the installation portion 217 between each of the plurality of blocking lumps 2171 and the bottom of the installation slot 2170.

The placing member 30 comprises a connecting board 31, an mounting portion 33 extending from one side of the connecting board 31, and a placing bracket 35 extending from another side of the connecting board 31. In one embodiment, the shape of the mounting portion 33 is substantially a column.

The outer wall of the mounting portion 33 is provided with a plurality of latching lumps 331. In one embodiment, each of the plurality of latching lumps 331 is the same shape. Each of the plurality of latching lumps 331 comprises a positioning portion 3311 and a stopper portion 3313. A receiving slot 333 is defined in the mounting portion 33 between adjacent two of the positioning portions 3311, for corresponding to each of the plurality of blocking lumps 2171. A stopper slot 335 is defined between each of the positioning portion 3311 and the connecting board 31. The stopper slot 335 communicates with the receiving slot 333. One end of the stopper portion 3313 is connected to the positioning portion 3311 and the other end is connected to the connecting board 311. In one embodiment, each of the plurality of latching lumps 331 is substantially “L” shaped.

The placing bracket 35 comprises a first supporting portion 351, a second supporting portion 353, and a dividing board 355. The dividing board 355 separates the first supporting portion 351 and a second supporting portion 353. Two first hooks 3511 extend separately from the first supporting portion 351. A first cutout 3513 is defined between the two first hooks 3511. A second hook 3531 extends from the second supporting portion 353. A second cutout 326 is defined between the second hook 3531 and the dividing board 355.

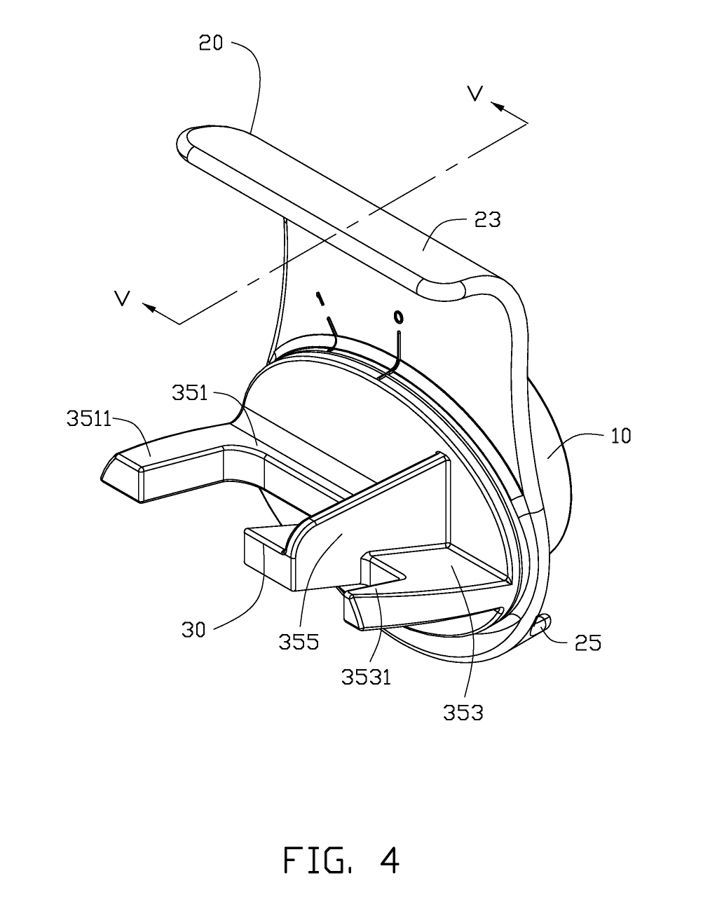

Referring to FIGS. 1-5, in assembly, each of the plurality of latching lumps 331 of the placing member 30 is aligned with each of the installation groove 2173 of the installation member 20. Each of the plurality of blocking lumps 2171 of the installation member 20 is aligned with each of the receiving slot 333 of the placing member 30. The placing member 30 is pressed towards the installation member 20, and the mounting portion 33 is engaged with the installation slot 2170 of the installation member 20. The placing member 30 is rotated in a first direction relative to the installation member 20, until each of the plurality of blocking lumps 2171 of the installation member 20 is blocked by corresponding one of the stopper portion 3313. In a first position, each of the plurality of blocking lumps 2171 is received in each of the stopper slot 335, and each of the positioning portion 3311 is received in each of the blocking slot 2175. The placing member 30 is secured to the installation member 20.

The latching portion 15 of the attachment dish 10 is aligned with the entrance 2118 of the installation member 20. The latching portion 15 is pushed towards the receiving space 212 and extends through the entrance 2118. The limiting portion 215 is elastically deformed, until the latching portion 15 is received in the receiving space 212. The neck portion 133 of the attachment dish 10 is received in the latching opening 2119. Thus, the limiting portion 215 is elastically reverted, and the latching portion 15 is secured between the limiting position 215 and the side board 2115. The pressing portion 131 abuts the side board 2115. The protrusion 213 prevents the latching portion 15 from disengaging from the receiving space 212.

Referring to FIG. 6, in use, the suction cup 11 of the attachment dish 10 is attached to the plane 90. The bracket for households is then attached on the plane 90, and the abutting portion 25 abuts to the plane 90 for positioning the placing member 30. The razor 50 comprises a razor body 51, and an operating portion 52 connecting the razor body 51. When the razor 50 is placed on the bracket for holding households, the razor body 51 is positioned on the first supporting portion 351, and the operating portion 52 is positioned in the first cutout 3513. A holding case 60 with blades is placed on the second supporting portion 353.

To disassemble the placing member 30, the placing member 30 is rotated in a second direction opposite to the first direction until each of the plurality of blocking lumps 2171 is disengaged from each of plurality of the latching lumps 331.

It is to be understood, however, that even though numerous characteristics and advantages have been set forth in the foregoing description of embodiments, together with details of the structures and functions of the embodiments, the disclosure is illustrative only and changes may be made in detail, especially in matters of shape, size, and arrangement of parts within the principles of the disclosure to the full extent indicated by the broad general meaning of the terms in which the appended claims are expressed.

What is claimed is:

1. A bracket comprising:
an installation member, the installation member comprising an installation body, a receiving portion and a limiting portion located on the installation body, and a latching opening defined in the receiving portion;
an attachment dish, the attachment dish comprising a suction cup for sucking on a plane, a connecting portion extending from the suction cup, and a latching portion extending from the connecting portion; the latching portion elastically engaged between the receiving portion and the limiting portion; and the connecting portion engaged in the latching opening; and
a placing member rotatably secured to the installation member for supporting a household item.

2. The bracket of claim 1, wherein the receiving portion comprises a side board substantially paralleled with the limiting portion, and the latching opening defined in the side board.

3. The bracket of claim 2, wherein the receiving portion further comprises a first sidewall and a second sidewall, an entrance defined between the first sidewall and the second sidewall, a receiving space is defined between the first sidewall, the second sidewall, and the installation body, and the latching portion extending into the entrance to be received in the receiving space.

4. The bracket of claim 3, wherein the receiving portion further comprises a top wall connecting the first sidewall and the second sidewall, and a side board connecting to the first sidewall, the second sidewall and the top wall; the receiving space is further defined by the first sidewall, the second sidewall, the top wall and the side board; the latching portion is received in the receiving space.

5. The bracket of claim 3, wherein a protrusion is located on the installation body, the protrusion is configured to prevent the latching portion from disengaging from the receiving space.

6. The bracket of claim 1, wherein the placing member comprises a mounting portion, a plurality of latching lumps located on an outer wall of the mounting portion; the installation body defines an installation slot, a plurality of blocking lumps located on an inner wall of the installation slot; the placing member is secured to the installation member by engaging each of the plurality of latching lumps with each of the plurality of blocking lumps.

7. The bracket of claim 6, wherein each of the plurality of latching lumps comprises a positioning portion; the placing member further comprises a connecting board; a stopper slot is defined between the positioning portion and the connecting board; a blocking slot is defined between each of the plurality of blocking lumps and a bottom of the installation slot; the positioning portion is received in the blocking slot; and each of the plurality of latching lump is received in each of the stopper slot.

8. The bracket of claim 7, wherein a installation groove is defined between adjacent two of the plurality of blocking lumps; a receiving slot is defined between adjacent two of the positioning portions; and the placing member is rotatable relative to the installation member after each of the plurality of latching lumps extends into each of the installation groove and each of the plurality of blocking lumps extends into each of the receiving slot.

9. The bracket of claim 8, wherein each of the plurality of latching lumps further comprises a stopper potion connected to the connecting board and the positioning portion, and the stopper potion limits a rotating range of each of the plurality of blocking lumps.

10. The bracket of claim 1, wherein the connecting portion comprises a pressing portion extending from the suction cup and a neck portion extending from the pressing portion; the pressing portion abuts the latching portion; and the neck portion is received in the latching opening.

11. A bracket comprising:
an installation member, the installation member comprising an installation body, an installation slot defined in the installation body, a plurality of blocking lumps located on an inner wall of the installation slot;
a placing member configured to support a household item, the placing member comprising a mounting portion, a plurality of latching lumps positioned on an outer wall of the mounting portion; and
a attachment dish capable of attaching on a plane, the attachment dish comprising a latching portion, the latching portion elastically mounted in the installation body;
wherein the mounting portion is received in the installation slot, and the mounting portion is adapted to be rotated relative to the installation body between a first position and a second position; when the mounting portion is in the first position, each of the plurality of latching lumps is engaged with each of the plurality of blocking lumps; when the mounting portion is in the second position, each of the plurality of latching lumps is disengaged from each of the plurality of blocking lumps.

12. The bracket of claim 11, wherein a blocking slot is defined between each of the plurality of blocking portions and a bottom of the installation slot; the placing member further comprises a connecting board, a stopper slot is defined between each of the plurality of latching lumps and the connecting board; when the mounting portion is in the first position, each of the plurality of latching lumps is received in each of the blocking slot, and each of the plurality of blocking lumps is received in each of the stopper slot.

13. The bracket of claim 12, wherein each of the plurality of latching lumps comprises a positioning portion, and a stopper portion connected to the positioning portion and the connecting board; when the mounting portion is in the first position, each of the positioning portion is engaged with each of the plurality of blocking lumps, and the stopper potion limits a rotating range of each of the plurality of blocking lumps.

14. The bracket of claim 12, wherein the placing member further comprises a placing bracket extending from the connecting board, and the placing bracket comprises a first supporting portion, a second supporting portion separated from the first supporting portion by a dividing board.

15. The bracket of claim 11, wherein the installation member further comprises a abutting portion extending from one end of the installation body, and a covering portion for extending from another end of the installation body; the placing member abuts to the installation member via the abutting portion.

16. The bracket of claim 11, wherein a receiving portion is located on the installation body; a receiving space is defined in the receiving portion; and the latching portion is received in the receiving space.

17. The bracket of claim 16, wherein a limiting portion is positioned in the installation body; and the limiting portion abuts the latching portion to prevent the latching portion from disengaging from the receiving space.

18. The bracket of claim 16, wherein the receiving portion comprises a side board substantially paralleled with the limiting portion; a latching opening is defined in the side board; the attachment dish comprises a connecting portion; and the connecting portion is engaged in the latching opening.

19. The bracket of claim 17, wherein a protrusion is located on the installation body, the protrusion is configured to prevent the latching portion from disengaging from the receiving space.

20. The bracket of claim 18, wherein the connecting portion comprises a pressing portion and a neck portion extending from pressing portion; the neck portion is received in the latching opening, and the pressing portion abuts the side board.
